(19) United States
(12) Patent Application Publication
(10) Pub. No.: US 2004/0088410 A1
(43) Pub. Date: May 6, 2004

(54) Computer network architecture

(76) Inventors: Thomas J. Flynn, Magnoila, TX (US); Thomas L. Josefy, Houston, TX (US); Gary A. Willett, Katy, TX (US)

Correspondence Address: HEWLETT-PACKARD COMPANY, Intellectual Property Administration, P.O. Box 272400, Fort Collins, CO, 80527-2400, US

(21) Appl. No.: 10/289,008

(22) Filed: Nov. 6, 2002

(51) Int. Cl. G06F 15/173

(52) U.S. Cl. 709/225

(57) ABSTRACT

The disclosed embodiments relate to a network computing architecture and method that may employ thin client or other computing devices to provide a client computing interface. The client computing interface may generate requests for computing services when utilized by users. The client computing interface may be coupled connected to load balancing resources that may direct the requests for computing services to computing resources and data resources.

### BACKGROUND OF THE RELATED ART

This section is intended to introduce the reader to various aspects of art which may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Since the introduction of the first personal computer (“PC”) over 20 years ago, technological advances to make PCs more useful have continued at an amazing rate. Microprocessors that control PCs have become faster and faster, with operational speeds eclipsing a gigahertz (one billion operations per second) and continuing well beyond.

Productivity has also increased tremendously because of the explosion in the development of software applications. In the early days of the PC, people who could write their own programs were practically the only ones who could make productive use of their computers. Today, there are thousands and thousands of software applications ranging from games to word processors and from voice recognition to web browsers.

a. The Evolution of Networked Computing

In addition to improvements in PC hardware and software generally, the technology for making computers more useful by allowing users to connect PCs together and share resources between them has also seen rapid growth in recent years. This technology is generally referred to as “networking.” In a networked computing environment, PCs belonging to many users are connected together so that they may communicate with each other. In this way, users can share access to each other's files and other resources, such as printers. Networked computing also allows users to share internet connections, resulting in significant cost savings. Networked computing has revolutionized the way in which business is conducted across the world.

Not surprisingly, the evolution of networked computing has presented technologists with some challenging obstacles along the way. One obstacle is connecting computers that use different operating systems (“OSes”) and making them communicate efficiently with each other. Each different OS (or even variations of the same OS from the same company) has its own idiosyncrasies of operation and configuration. The interconnection of computers running different OSes presents significant ongoing issues that make day-to-day management of a computer network challenging.

Another significant challenge presented by the evolution of computer networking is the sheer scope of modem computer networks. At one end of the spectrum, a small business or home network may include a few client computers connected to a common server which may provide a shared printer and/or a shared Internet connection. On the other end of the spectrum, a global company's network environment may require interconnection of hundreds or even thousands of computers across large buildings, a campus environment, or even between groups of computers in different cities and countries. Such a configuration would typically include a large number of servers, each connected to numerous client computers.

Further, the arrangements of servers and clients in a larger network environment could be connected in any of a large number of topologies that may include local area networks (“LANs”), wide area networks (“WANs”) and municipal area networks (“MANs”). In these larger networks, a problem with any one server computer (for example, a failed hard drive, corrupted system software, failed network interface card or OS lock-up to name just a few) has the potential to interrupt the work of a large number of workers who depend on network resources to get their jobs done efficiently. Needless to say, companies devote considerable time and effort to keep their networks operating trouble-free to maximize productivity.

b. The Development of Thin Client Computing

Networks are typically populated with servers and client computers. Servers are generally more powerful computers that provide common functions such as file sharing and Internet access to the client computers. Traditionally, client computers have themselves been fully functional computers, each having a processor, hard drive, CD ROM drive, floppy drive, and system memory.

Recently, thin client computing devices have begun to appear. Thin client computing devices are generally capable of only the most basic functionality. Many thin client computers do not have their own hard drives, CD ROM drives, or floppy drives. Thin client computers may typically be connected to a network to boot an operating system or load application programs such as word processors or Internet browsers. Additionally, thin clients may have only a relatively small amount of system memory and may have a relatively slow processor compared to fully functional client computer workstations.

What thin clients lack in computing power, however, they make up for in other areas such as reliability. Thin clients may typically be more reliable than their fully functional counterparts because thin clients typically may have fewer parts. For example, many thin clients do not have their own hard drive. Because the hard drive is one of the most likely computer components to fail, the lack of a hard drive may account for a significant increase in the reliability of a thin client computer compared to a fully functional computer with its own hard drive.

The high reliability of thin clients makes them potentially desirable for use in a networked environment. Network maintenance costs are a significant expense in large network environments and companies and other organizations spend a large amount of resources to reduce those costs. Thin clients have the potential to reduce networking costs because of their relative simplicity and increased reliability with respect to fully functional client computers.

In a typical thin client networked environment, thin clients may be connected to a centralized server. The thin client computer may typically communicate with the server through a multi-user terminal server application program. The centralized server may be responsible for providing an operating system for the thin clients that are connected to it. Additionally, the centralized server may supply application programs such as word processing and Internet browsing to the thin clients as needed. The user's data, such as document files, spreadsheets, and Internet favorites, may be stored on the centralized server as well. Thus, when a thin client breaks, it may be removed and replaced without the need to transfer the user's programs to the replacement unit.

Nonetheless, the lack of computing power of some thin clients may have slowed their acceptance rate among network administrators. This slow acceptance may be partially true because of the methods of distributing computing power from the centralized server to thin client computers utilized. Problems may arise when a user of a thin client connected to a central server through a multi-user terminal server application begins the execution of a process that requires a relatively large amount of computing power. If the centralized server does not unable to distribute the computing load effectively, then other thin client users connected to the centralized server through the terminal server application may experience performance problems because of the portion of the power of the centralized server is being diverted to process the needs of a single user.

### BRIEF DESCRIPTION OF THE DRAWINGS

Advantages of the invention may become apparent upon reading the following detailed description and upon reference to the drawings in which:

FIG. 1 is a block diagram of a client-server computer network architecture;

FIG. 2 is a block diagram of an example of a network architecture according to embodiments of the present invention;

FIG. 3 is a functional block diagram that may be useful in explaining the operation of the network architecture according to embodiments of the present invention; and

FIG. 4 is a process flow diagram in accordance with embodiments of the present invention.

### DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

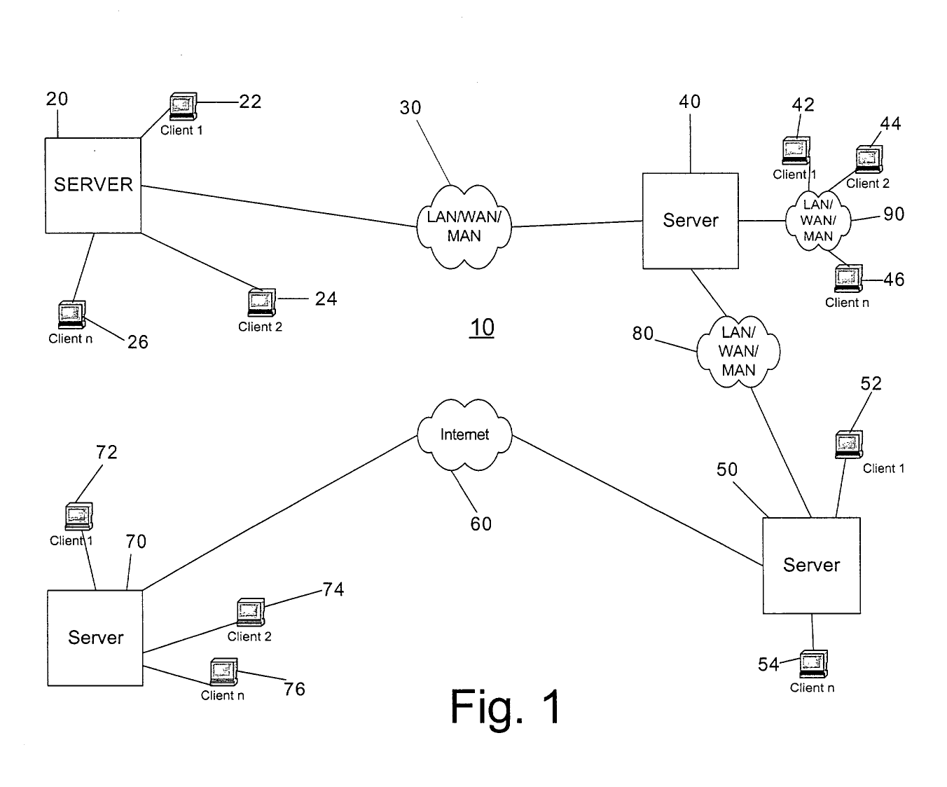

Turning now to the drawings and referring initially to FIG. 1, a block diagram of a computer network architecture is illustrated and designated using a reference numeral 10. A server 20 is connected to a plurality of client computers 22, 24 and 26.

The server 20 may be connected to as many as n different client computers. Each client computer in the network 10 may be a fully functional client computer. The magnitude of n may be a function of the computing power of the server 20. If the server 20 has large computing power (for example, faster processor(s) and/or more system memory), it may be able to effectively serve a large number of client computers.

The server 20 is connected via a network infrastructure 30, which may include any combination of hubs, switches, routers, and the like. While the network infrastructure 30 is illustrated as being either a local area network (“LAN”), a wide area network (“WAN”) or a municipal area network (“MAN”), those skilled in the art will appreciate that the network infrastructure 30 may assume other forms or may even provide network connectivity through the Internet. As will be described, the network 10 may include other servers, which may be widely dispersed geographically with respect to the server 20 and to each other to support client computers in other locations.

The network infrastructure 30 connects the server 20 to server 40, which may be representative of any other server in the network environment of server 20. The server 40 may be connected to a plurality of client computers 42, 44, and 46. As illustrated in FIG. 1, a network infrastructure 90, which may include a LAN, a WAN, a MAN or other network configuration, may be used to connect the client computers 42, 44 and 46 to the server 40. The server 40 is additionally connected to server 50, which is in turn connected to client computers 52 and 54. A network infrastructure 800, which may include a LAN, a WAN, a MAN or other network configuration, may be used to connect the client computers 52, 54 to the server 50. The number of client computers connected to the servers 40 and 50 may be dependent on the computing power of the servers 40 and 50, respectively.

The server 50 may additionally be connected to the Internet 60, which may in turn be connected to a server 70. The server 70 may be connected to a plurality of client computers 72, 74 and 76. The server 70 may be connected to as many client computers as its computing power will allow.

Those of ordinary skill in the art will appreciate that the servers 20, 40, 50, and 70 may not centrally located. A network architecture, such as the network architecture 10, may typically result in a wide geographic distribution of computing resources that must be maintained. The servers 20, 40, 50, and 70 must be maintained separately. Also, the client computers illustrated in the network 10 are subject to maintenance because each may itself be a fully functional computer that stores software and configuration settings on a hard drive or elsewhere in memory. In addition, many of the client computers connected with the network 10 may have their own CD-ROM and floppy drives, which may be used to load additional software. The software stored on the fully functional clients in the network 10 may be subject to damage or misconfiguration by users. Additionally, the software loaded by users of the client computers may itself need to be maintained and upgraded from time to time.

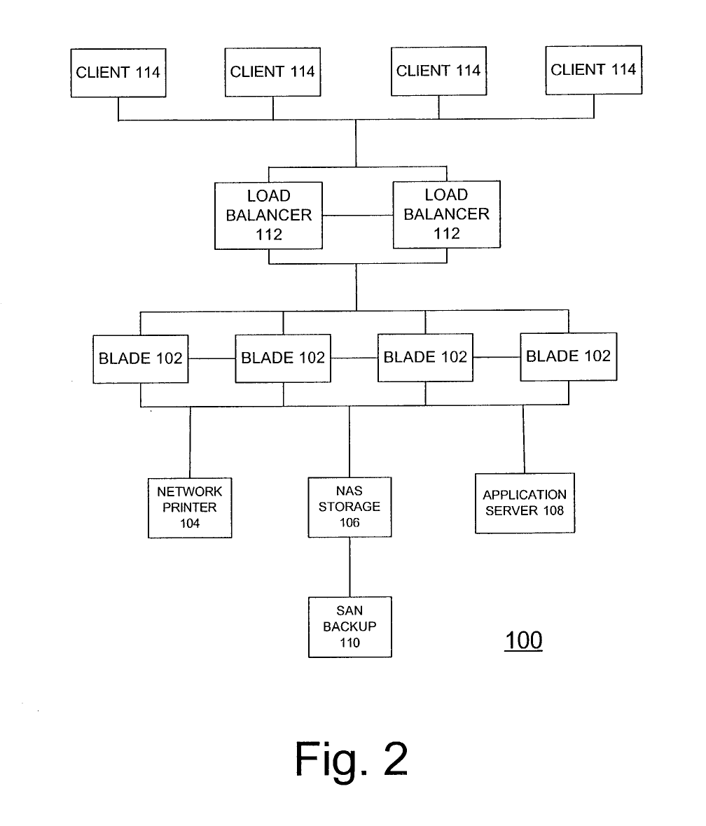

FIG. 2 is a block diagram of an example of a network architecture in accordance with embodiments of the invention. The network architecture is referred to generally by the reference numeral 100.

A plurality of server blades 102 are connected together to form a centralized computing engine. A server blade may include many components of a server on a printed circuit board, which may be referred to as a blade. Examples of components that may be included on a server blade may include a network interfaces, a CPU, system memory and/or a hard disk. Server blades may be installed by plugging them into an enclosure, such as a cabinet or chassis. It may be possible to include more server blades in the space previously occupied by non-blade servers. In addition, server blades may provide additional computing power while reducing power consumption, cooling requirements and/or cabling complexity. Power and networking connections may be provided by server blade backplanes into which multiple server blades may be plugged.

Four server blades are shown in the network architecture 100 for purposes of illustration, but server blades may be added to or removed from the computing engine as needed. The server blades 102 may be connected by a network infrastructure so that they may share information. PCI-X, Infiniband or any other suitable network infrastructure may be examples of network infrastructures that may be employed to interconnect the server blades 102 together.

The server blades 102 may be connected to additional computing resources, such as a network printer 104, a network attached storage (“NAS”) device 106, and/or an application server 108. NAS devices, such as the NAS device 106, may be specialized file serving devices that provide support for heterogeneous files in a high capacity package. NAS may also provide specific features to simplify the tasks and reduce the resources associated with data storage and management. A NAS solution may work with a mix of clients and servers running different operating systems.

The NAS device 106 may be connected to a back-up device such as a storage attached network (“SAN”) back-up device 110. A SAN may be a storage architecture in which storage devices may be connected together on an independent network with respect to servers and client computers. SANs may be used to provide back-up capability in a NAS storage environment.

The server blades 102 may additionally be connected to a plurality of load balancers 112. For purposes of illustration, two load balancers 112 are shown. Additional load balancers may be added to facilitate handling of larger amounts of network traffic or other reasons. The load balancers 112 may comprise load balancing switches or routers, or any other device that may distribute the computing load of the network among the plurality of server blades 102. The load balancers 112 may be connected to a plurality of client computers 114 and are adapted to receive network traffic, including requests to perform computing services, such as to perform computing tasks or store or print data. While four client computers are illustrated, a lesser or greater number may be employed.

The load balancers 112 may distribute requests among the server blades 102 according to any protocol or scheme. Examples of distribution schemes that may be used are round-robin distribution or use-based distribution schemes. In a round-robin distribution scheme, no consideration is taken for whether the server blade requested to perform a task is under-utilized or over-utilized. Instead, requests are simply passed to the server blades in a predetermined. In a use-based distribution scheme, the load balancers 112 may have the capability to communicate with the server blades 102 to determine the relative workload being performed by each of the server blades 102. Requests for additional work may be forwarded to a server blade that may service the request.

The client computers 114 may comprise thin client computer systems. The load balancers 112 may be connected to the client computers through a single-user terminal server program such as the single-user terminal server utility that is provided as part of the Microsoft Windows XP operating system, which is available from Microsoft Corporation of Redmond, Wash. Other single-user terminal server applications may be used, as well.

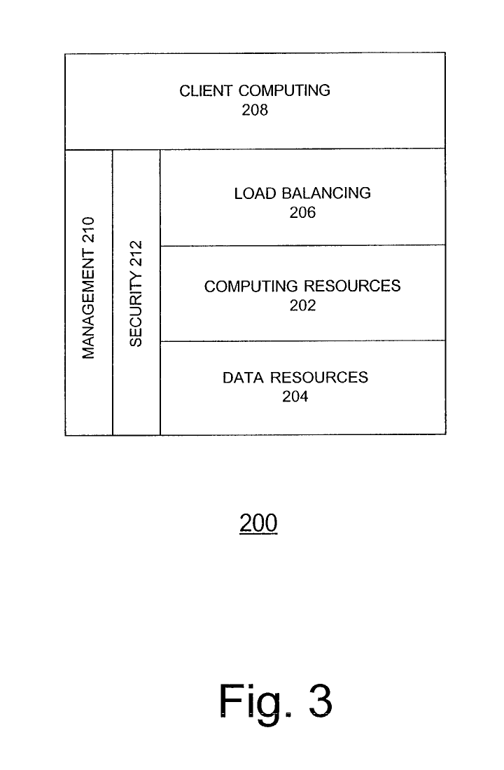

FIG. 3 is a functional block diagram that is useful in explaining the network architecture in accordance with embodiments of the invention. The functional diagram is generally referred to by the reference numeral 200. Computing resources 202 may be provided by the server blades 102 (FIG. 2), which comprise a scalable computing engine. Server blades may be added to the computing engine or removed from it as needed or advantageous. Network data resources 204 may be provided, for example, by the network printer 104, the network attached storage 106, the server attached network back-up device 110, the application server 108, or other resources.

A load balancing function 208 is provided, at least in part, by the load balancers 112. The load balancers 112 may receive network data from the client computers 114 may and provide the requests for computing services to the server blades 102.

Client computing services 208 may be provided by the client computers 114. Because the client computers 114 may be thin client computers, they may require less maintenance resources than traditional fully functional client computers. Typically, thin client computer systems do not have several of the parts that are the most likely to fail in a fully functional client computer system. For example, if clients 114 are thin clients, they may not have a hard drive, CD-ROM drive, or even a cooling fan. Accordingly, the thin client computer systems may depend on the computing resources 202 provided by the server blades 102 for an operating system and for application programs (which may be provided by the application server 108). This means that users may not contribute to maintenance problems by loading additional software that may need to be supported or that may be incompatible with the network environment. The fact that users of the thin client computers may not load software may additionally help to prevent the introduction of viruses into the network environment.

In addition, the users of thin client computer systems 114 may utilize the data resource 204 functionality for storing application data such as word processing documents and spread sheets. This means that user data may be conveniently backed up using the SAN back-up device 110. If a problem develops with one of the client computer systems 114 and it is a thin client, the thin client computer system may be easily removed and replaced without significant reconfiguration. This is true because the user's application and configuration data is stored elsewhere. The replacement of a user's thin client computer may be completely transparent to the user.

Each of the thin client computers 114 may be connected to the load balancers 112 by a single-user terminal server application. The use of a single-user terminal server application in conjunction with the load balancing function 206 may help ensure that individual requests for a large volume of computing power may not significantly interfere with the operation of the remaining client computers. Requests for the computing resources function 202 (computing power) may be are evenly distributed among the server blades 102, depending, for example, on which blade has computing power available. When one server blade 102 is occupied with a compute-intensive task for each client 114, additional requests for computing power from other clients may be diverted to server blades that are available.

A management function 210 and a security function 212 may be provided to the centralized load balancing function 206, the computing resources 202 and the data resources 204. The client computers 114, if they are thin client computers, require practically no management or security services because of their dependence on the functionality provided by the network architecture.

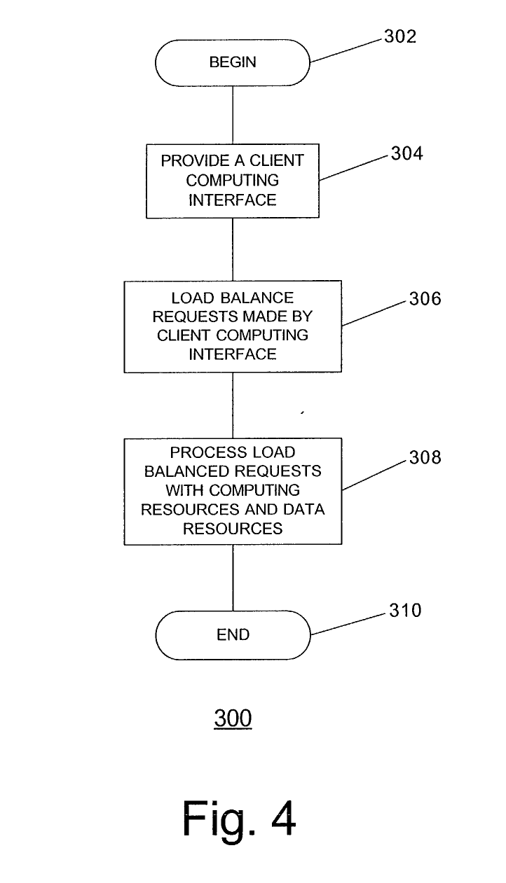

FIG. 4 is a process flow diagram in accordance with embodiments of the invention. The process is generally referred to by the reference numeral 300. At block 302, the process begins. At block 304, a client computing interface is provided. The client computing interface may be in the form of a plurality of client computing devices 114 (FIG. 2) that may be thin client computing devices. After one or more thin clients are initialized, the initialized clients may be connected to load balancing resources using a single-user terminal server program. The client computing interface may generate requests for computing service as users perform computing tasks. The requests for computing services may then be load balanced, as shown at block 306. The use of load balancing helps to ensure that the requests for services are responded to in an efficient manner.

As shown at block 308, a computing resource (such as the server blades 102 (FIG. 2)) and a data resource (such as the network printer 104, the network attached storage device 106, the SAN back-up device 110 and/or the application server 108 or other resources (FIG. 2)) may be used to process the requests for computing services. At block 310, the process ends.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A computer network architecture, comprising:
a client computing interface adapted to generate requests for computing services;
a load balancing resource adapted to receive the requests for computing services and direct, in part, the requests for computing services for further processing by available resources;
a computing resource adapted to receive and process selected requests for computing services from the load balancing resource; and
a data resource coupled to the computing resource to process certain of the selected requests for computing services.

2. The computer network architecture of claim 1, wherein the client computing interface comprises a plurality of thin client computing devices.

3. The computer network architecture of claim 2, wherein the plurality of thin client computing devices are each connected to the load balancing resource by a single-user terminal server application.

4. The computer network architecture of claim 1, wherein the computing resource comprises a plurality of server blades.

5. The computer network architecture of claim 1, wherein the data resource comprises a network attached storage device.

6. The computer network architecture of claim 5 comprising a storage area network back-up device connected to the network attached storage device.

7. A method of operating a computer network, the method comprising the acts of:
providing a client computing interface that generates requests for computing services;
load balancing the requests for computing services; and
processing the load balanced requests for computing services.

8. The method of claim 7, wherein the client computing interface comprises a plurality of thin client computing devices.

9. The method of claim 8 comprising connecting each of the plurality of thin client computing devices to the load balancing resource using a single-user terminal server application.

10. The method of claim 7, wherein the computing resource comprises a plurality of server blades.

11. The method of claim 7 comprising storing data on a network attached storage device in response to one of the requests for computing services.

12. The method of claim 11 comprising backing up data on a storage area network back-up device.

13. The method of claim 7, wherein the recited acts are performed in the recited order.

14. A computer network architecture, comprising:
a plurality of thin client computing devices, each of which is adapted to execute a single-user terminal server application and to generate requests for computing services;
a load balancing resource adapted to receive the requests for computing services and use a distribution scheme to direct the requests for computing services for further processing by available resources;
a computing resource adapted to receive and process selected requests for computing services from the load balancing resource; and
a data resource coupled to the computing resource to process certain of the selected requests for computing services.

15. The computer network architecture of claim 14, wherein the computing resource comprises a plurality of server blades.

16. The computer network architecture of claim 14, wherein the data resource comprises a network attached storage device.

17. The computer network architecture of claim 16 comprising a storage area network back-up device connected to the network attached storage device.

18. A computer network architecture, comprising:
client computing means for generating requests for computing services;
load balancing means for receiving the requests for computing services and directing the requests for computing services for further processing by available resources;
computing means for receiving and processing selected requests for computing services from the load balancing means; and
data resource means for processing certain of the selected requests for computing services.

19. The computer network architecture of claim 18, wherein the client computing means comprises a plurality of thin client computing devices.

20. The computer network architecture of claim 19, wherein the plurality of thin client computing devices are each connected to the load balancing means by a single-user terminal server application.

21. The computer network architecture of claim 18, wherein the computing means comprises a plurality of server blades.

22. The computer network architecture of claim 18, wherein the data resource means comprises a network attached storage device.

23. The computer network architecture of claim 22, comprising a storage area network back-up device connected to the network attached storage device.
